(19) United States
(12) Patent Application Publication
(10) Pub. No.: US 2018/0237132 A1
(43) Pub. Date: Aug. 23, 2018

(54) VERTICAL TAKE-OFF AND LANDING FIXED-WING AIRCRAFT AND THE FLIGHT CONTROL METHOD THEREOF

(71) Applicant: Shanghai Fukun Aviation Technology Co., Ltd., Shanghai (CN)

(72) Inventors: SHIYI LIU, SHANGHAI (CN); LING XIE, SHANGHAI (CN)

(21) Appl. No.: 15/751,486

(22) PCT Filed: Aug. 12, 2016
(86) PCT No.: PCT/CN2016/094826

§ 371 Date: Feb. 9, 2018

(30) Foreign Application Priority Data
Aug. 12, 2015 (CN) 201520605032.4

(51) Int. Cl. B64C 27/26; B64C 27/30

(52) U.S. Cl. CPC B64C 27/26; B64C 2027/8236; B64C 27/30

(57) ABSTRACT

Provided is a vertical take-off and landing fixed-wing aircraft and the flight control method thereof, the fixed-wing aircraft including a fuselage, fixed-wings and a thruster both configured on the fuselage. A storage room is configured inside the fuselage, a plurality of openings and their corresponding doors are configured on the fuselage and the openings are connected to the storage room. A driving mechanism, and a deployable supporting mechanism are arranged inside the storage room, and the outer ends of the deployable supporting mechanism are provided with vertical lifters. The fixed-wing aircraft can be in an open state and a closed state, in the open state, the doors open and the vertical lifters spread out outside the storage room through the doors; in the closed state, the vertical lifters are located within the storage room while the doors closed.

### CROSS-REFERENCE TO RELATED APPLICATIONS

This application claims priority to PCT Application No. PCT/CN2016/094826, having a filing date of Aug. 12, 2016, based on CN 201520605032.4, having a filing date of Aug. 12, 2015, the entire contents both of which are hereby incorporated by reference.

### FIELD OF TECHNOLOGY

The following relates to a field of aircraft, in particular to a vertical take-off and landing (VTOL) fixed-wing aircraft and the flight control method thereof.

### BACKGROUND

It is known that fixed-wing aircraft can generate a lift force itself by its wings moving through airflow, allowing for high speed and long flight, heavy loaded and efficiency, whereas it needs a long airstrip, and cannot hover overhead. Rotorcraft uses lift force generated by rotary wings, and can be thrust horizontally by controlling the pitching angle of the rotary wings. The merit of rotorcraft includes a simple structure, being able of vertical take-off and landing and being able of hover in the air, whereas the shortage includes low speed, short range, light loaded and low efficiency.

Therefore, it is desirable to combine the merits of fixed-wing aircraft and rotorcraft with many attempts.

V22 Osprey in US uses the tiltrotor technical solution. The aircraft is in a rotorcraft mode capable of vertical take-off and landing while rotary plane of the rotary wings is horizontal. When the aircraft needs a horizontal movement, their rotary plane of the rotary wings tilts to a vertical direction so that the thrust force is generated by the rotary wings.

Another VTOL aircraft is a tail-sitter type, i.e. the aircraft tilts vertically, takes off and lands on its tail while the rotary plane of the rotary wings is parallel to ground, and the rotary wings provides a lift force, then the aircraft tilts horizontally for forward flight while the rotary plane of the rotary wings is vertical to ground, and the rotary wings provides a thrust force.

Under the constraints that the capacity of the battery is limited, the problem we are facing is how to enhance the load capacity, the airborne time and the range of aircraft, especially an unmanned aerial vehicle. Although existing design provides a solution as to vertical take-off and landing of fixed-wing aircraft, it is not an optimal solution of energy efficiency as the rotary wings require peculiarly contrary design in the aspect about energy efficiency when being used for horizontal thrust or vertical take-off and landing, that is, the rotary wings for horizontal thrust require small diameter, small pitch and small thrust, whereas the rotary wings for vertical take-off and landing require larger diameter, larger pitch and larger thrust. Existing tiltrotor and tail-sitter type solutions take both thrust and hover into account, resulting in a non-optimal status both operations in the aspect about energy efficiency.

### SUMMARY

An aspect relates to a vertical take-off and landing fixed-wing aircraft and the flight control method thereof. The following may operate not only in high-speed cruise mode but also in vertical take-off and landing mode, and can achieve optimal energy efficiency in both modes.

Technical solution of embodiments of the present invention are as follows: A VTOL fixed-wing aircraft, comprises a fuselage, fixed-wings and a thruster both configured in the fuselage, a storage room is configured inside the fuselage, a plurality of openings and their corresponding doors are configured on the fuselage, and the openings are connected to the storage room; a driving mechanism, and a deployable supporting mechanism driven by the driving mechanism are arranged inside the storage room, and the outer ends of the deployable supporting mechanism are provided with vertical lifters; the fixed-wing aircraft can be in an open state and a closed state, in the open state, the doors open and the vertical lifters spread out outside the storage room through the doors, by the act of the deployable supporting mechanism; in the closed state, the vertical lifters are located within the storage room by act of the deployable supporting mechanism while the doors closed.

Further, at least two vertical lifters are arranged, in the open state, the at least two vertical lifters are located on opposite sides of the fuselage.

The fuselage is further provided with a horizontal rotation shaft, the thruster is movable mounted to the fuselage via the rotation shaft.

The deployable supporting mechanism comprises a first supporting arm, the middle part of which is movably connected to the fuselage via a hinge shaft, and at least two vertical lifters are mounted on both ends of the first supporting arm.

The deployable supporting mechanism further comprises a second supporting arm, the middle parts of both the first supporting arm and the second supporting arm are both movably hinged to the hinge shaft, to form an “X” shape, all outer ends of both the first supporting arm and the second supporting arm are provided with the vertical lifters respectively, the hinge shaft is connected to the fuselage.

Further, the first supporting arm and the second supporting arm are located on opposite sides of the hinge shaft.

Further, each of the first supporting arm and the second supporting arm are arranged with a hinge segment, a first end arm and a second end arm, and the first supporting arm and the second supporting arm are hinge-jointed via the hinge shaft at their hinge segments. The first end arm and the second end arm are arranged on opposite sides of the hinge segment respectively. The extension lines of the first and second end arms of the first supporting arm are located on opposite sides of the hinge shaft, so do the extension lines of the first and second end arms of the second supporting arm; the extension lines of the first end arm of both the first and second supporting arms are located on opposite sides of the hinge shaft, so do the extension lines of the second end arm of both the first and second supporting arms.

Further, the first supporting arm and the second supporting arm are both arranged with a hinge segment, a first end arm and a second end arm, and the first supporting arm and the second supporting arm are hinge-jointed via the hinge shaft at their hinge segments. The first end arm and the second end arm are arranged on opposite sides of the hinge segment respectively. The hinge segment of the first supporting arm is located above that of the second supporting arm, each of the first supporting arm and the second supporting arm includes an upper surface and a lower surface. The vertical lifter includes an installation base and a rotary wing, and the rotary wing is fixed on the installation base. Two vertical lifters on the first supporting arms are mounted on the lower surface of the first supporting arm via their installation base, and the two vertical lifters on the second supporting arms are mounted on the upper surface of the second supporting arm via their installation base.

Further, positive stops are provided about the first supporting arm and the second supporting arm, in a stop state, the first supporting arm and the second supporting arm are spread out maximally.

Further, the first supporting arm and the second supporting arm are provided with a first pin and a second pin respectively, and the first pin and the second pin are located on opposite sides of the hinge shaft. The positive stops comprise a first pin and a second pin.

Further, the driving mechanism includes a rotator, a slider and a guider. The rotator and the guider are arranged on the fuselage. The slider is slid-fitted with the guider. The slider is provided with a slot, and the rotator is provided with a finger which is inserted into the slot and is deviated from the rotary axis of the rotator. A first slide element and a second slide element are arranged on the slider, the first pin and the second pin are inserted into the first slide element and the second slide element respectively.

Further, the hinge shaft comprises an outer shaft fixed to the first supporting arm, and an inner shaft fixed to the second supporting arm, the outer shaft is sleeved on the inner shaft.

Further, there are two doors which are located on opposite sides of the fuselage respectively.

Further, the fixed-wings are located on both sides of the fuselage, the hinge shaft is located near the back portion of the fixed-wings. In the open state, two vertical lifters will be located ahead of the fixed-wings.

A VTOL fixed-wing aircraft, comprises a fuselage, fixed-wings and a thruster both configured in the fuselage; a storage room is configured inside the fixed-wings, a plurality of openings and their corresponding doors are configured on the fixed-wing, and the openings are connected to the storage room; a driving mechanism 30, and a deployable supporting mechanism driven by the driving mechanism 30 are arranged inside the fixed-wings, and the outer ends of the deployable supporting mechanism are provided with vertical lifters; the fixed-wing aircraft can be in an open state and a closed state, in the open state, the doors open and the vertical lifters spread out outside the storage room through the doors, by the act of the deployable supporting mechanism; in the closed state, the vertical lifters are located within the storage room by act of the deployable supporting mechanism while the doors closed.

Further, the fixed-wings are two fixed-wings which are arranged on opposite sides of the fuselage, each fixed-wing is fixed with two vertical lifters by the deployable supporting mechanism.

Further, the vertical lifters are two vertical lifters; the fuselage is provided with a horizontal rotation shaft, and the thruster is movable mounted to the fuselage via the rotation shaft.

A flight control method of a VTOL fixed-wing aircraft, when the fixed-wing aircraft takes off, lands or hover, doors open and spread out a deployable supporting mechanism by act of a driving mechanism thereby vertical lifters work and are located outside of a storage room; during the fixed-wing aircraft is under high speed cruise, gather the deployable supporting mechanism including the vertical lifters into the storage room by act of the driving mechanism and close the doors thereby a thruster works.

It should be noted that,

The preceding words “first”, “second” do not represent specific quantity or order, merely for the purpose of distinguishing parts' names.

The advantages or principle of embodiments of the invention are as follows:
1. When the fixed-wing aircraft takes off, lands or hovers, the doors open, and the deployable supporting mechanism is spread by act of the driving mechanism, thereby the vertical lifers will be working outside the storage room to provide the aircraft with large lift force in vertical direction; during the high speed cruise, the deployable supporting mechanism is gathered within the storage room, by act of the driving mechanism, that time the doors close, and the thruster works so as to make the aircraft to achieve a high efficiency and long range due to fully utilization of the aerodynamic efficiency of the fixed-wing.
2. In the open state, at least two vertical lifters are located on both sides of the fuselage, to provide a lift force for the aircraft during vertical take-off and landing or hover; if only two vertical lifters are provided on both sides of the fuselage, it is necessary to utilize a thruster with tiltable structure to control the flight attitude in vertical direction.
3. The deployable supporting mechanism comprises a first supporting arm, and two vertical lifters are mounted to both ends of the first supporting arm respectively so that the lift requirement can be perfectly met with simple structure.
4. The middle parts of the first supporting arm and the second supporting arm are all hinged to a hinge shaft such that the first supporting arm and the second supporting arm form an “X” shape, such structure has the following advantages.
   A. When the first supporting arm and the second supporting arm are parallel, they are in a closed state, that is, the supporting arms and the vertical lifters thereon are located in the storage room; when the first supporting arm and the second supporting arm are arranged at a certain angle, they are in an open state, and the vertical lifters will be outside the storage room; the “X” shaped structure is simple and facilitate gathering and spreading;
   B. The hinge portions of the first supporting arm and the second supporting arm will bear a large bending moment. Such “X” shaped structure thereof ensure sufficient bending strength and rigidity in the hinged portion of the first supporting arm and the second supporting arm;
   C. Such “X” shaped structure formed by both the first supporting arm and the second supporting arm allows larger expanded plane during the open state and smaller compact space during closed state.
5. Each of the first supporting arm and the second supporting arm comprises the hinge segment, the first end arm and the second end arm, the first end arm and the second end arm are arranged on opposite sides of the hinge shaft, ensuring the first supporting arm and the second supporting arm to be parallel during the closed state, to avoid more space being occupied due to incomplete gather thereof
6. The first supporting arm and the second supporting arm all have a thickness, thus they cannot be in a same plane when they are hinge-jointed, which will affect the stability of the aircraft when it is vertically raised. During the installation, two vertical lifters on the first supporting arms are mounted on the bottom surface of the ends of the first supporting arms, and two vertical lifters on the second supporting arms are mounted on the top surface of the ends of the second supporting arms. This installation arrangement can ensure the four vertical lifters being in a same horizontal plane to improve the stability of the aircraft.
7. Positive stops are provided about the first supporting arm and the second supporting arm to limit the location of the first supporting arm and the second supporting arm when the first supporting arm and the second supporting arm are spread out, so that the reliability of the aircraft is guaranteed during flight.
8. The first supporting arm and the second supporting arm are all provided with a first pin and a second pin respectively, the driving mechanism may act on the first pin and the second pin that located on two opposite sides of the hinge shaft, then the first supporting arm can rotate in reverse relative to the second supporting arm to implement their gather or spread.
9. The driving mechanism comprises a rotator, a slider and a guider, when the rotator rotates, the finger pushes the slider to slide in horizontal direction along the guider, whereby the first pin and the second pin bring the first supporting arm and the second supporting arm to spread out or gather together.
10. The hinge shaft comprises an outer shaft fixed to the first supporting arm and an inner shaft fixed to the second supporting arm, the sleeve structure of the outer shaft has a larger thrust surface, which can reduce the possibility of skew or distortion between the first supporting arm and the second supporting arm. Such sleeve structure is very important to ensure the reliability of the hinge portions.
11. Two doors are located on opposite sides of the fuselage to facilitate the deployable supporting mechanism gathering together and spreading out.
12. The foresaid storage room, doors and deployable supporting mechanism may be provided in the fixed-wing, their working principle is same as the foresaid structure (i.e. the storage room, the doors, the deployable supporting mechanism, etc. are arranged on the fuselage), and more space can be left to make the structure more compact.
13. Arranging the storage room, doors and deployable supporting mechanism etc. on the fixed-wing, and using the following specific solution,
   A. Vertical lifters are arranged on the fixed-wings on both sides of the fuselage so that the fixed-wing aircraft can obtain a better balance when it takes-off, lands, or hovers.
   B. The vertical lifters are arranged on both sides the aircraft, the thruster is movable mounted to the fuselage to enhance the balance of the fixed-wing aircraft when it takes-off, lands, or hovers. During high-speed cruise, the thruster offers thrust force, and when takes-off and lands, the thruster rotates until its own axis is vertical, then the thruster controls the flight attitude in vertical direction.

### BRIEF DESCRIPTION

Some of the embodiments will be described in detail, with reference to the following figures, wherein like designations denote like members, wherein:

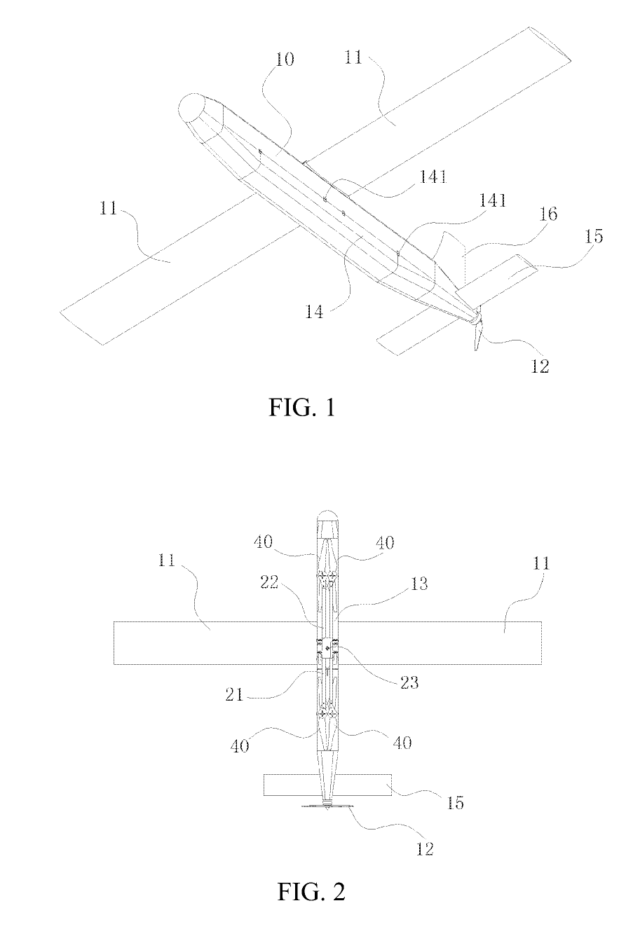

FIG. 1 is a bottom, perspective view of a VTOL fixed-wing aircraft according to a first embodiment of the present invention, during high speed cruise;

FIG. 2 is a structural view of the aircraft of FIG. 1, wherein doors in the aircraft are not shown;

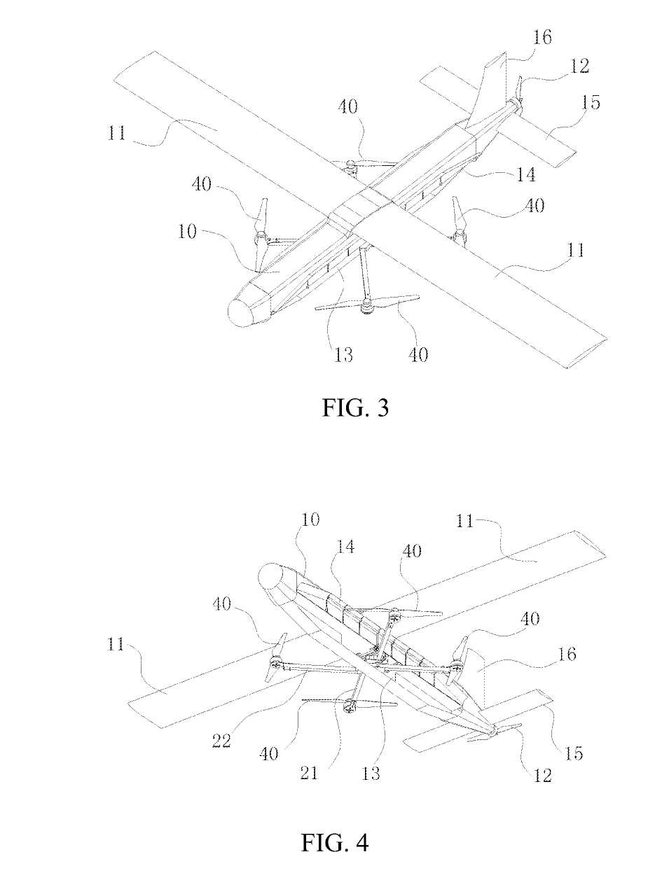

FIG. 3 is a top, perspective view of the VTOL fixed-wing aircraft according to a first embodiment of the present invention, during vertical take-off or landing, or hover;

FIG. 4 is a bottom, perspective view of the VTOL fixed-wing aircraft according to a first embodiment of the present invention, during vertical take-off or landing, or hovering;

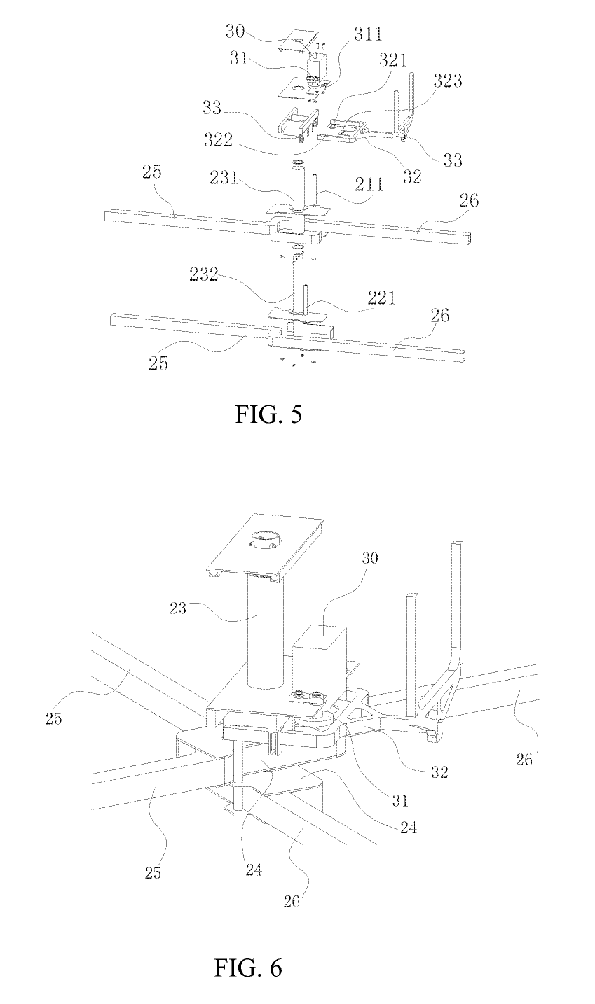

FIG. 5 is an explored view of a deployable supporting mechanism and a driving mechanism according to a first embodiment of the present invention;

FIG. 6 is a schematic view of the deployable supporting mechanism and the driving mechanism in an open state, according to a first embodiment of the present invention;

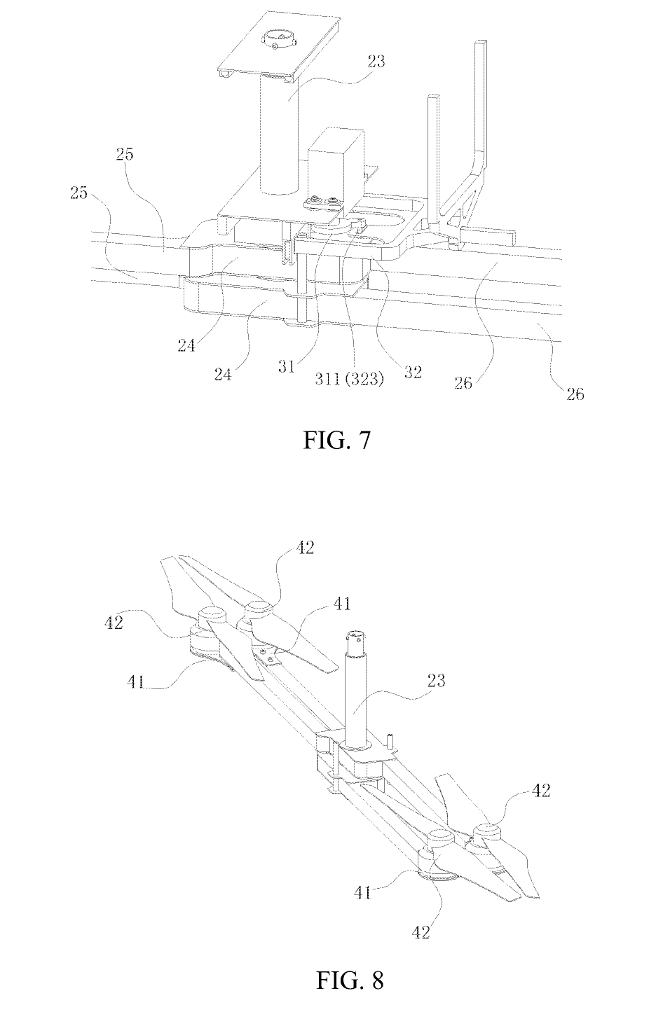

FIG. 7 is a schematic view of the deployable supporting mechanism and the driving mechanism in a closed state, according to a first embodiment of the present invention;

FIG. 8 is an installation structural view of the deployable supporting mechanism and a vertical lifter in a closed state, according to a first embodiment of the present invention;

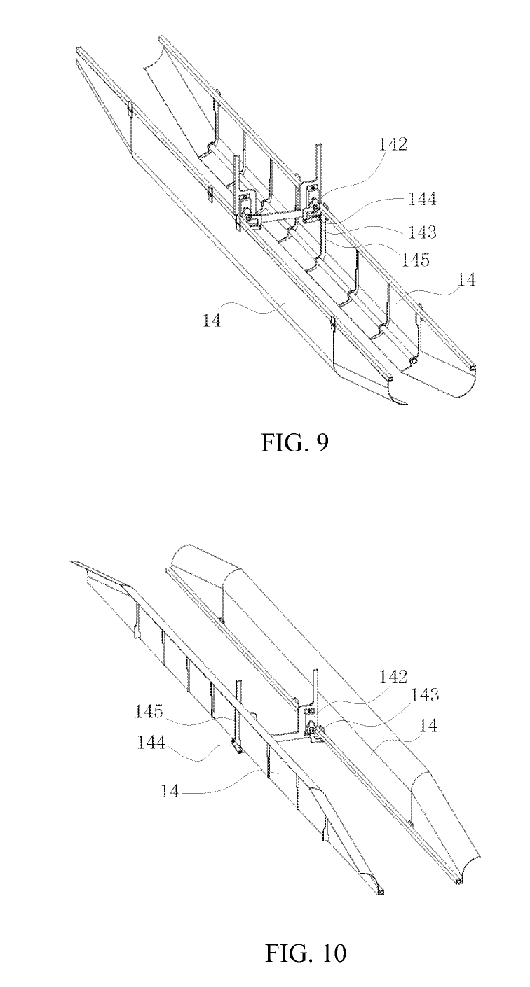

FIG. 9 is a structural view of a door in a closed state, according to a first embodiment of the present invention;

FIG. 10 is a structural view of a door in an open state, according to a first embodiment of the present invention;

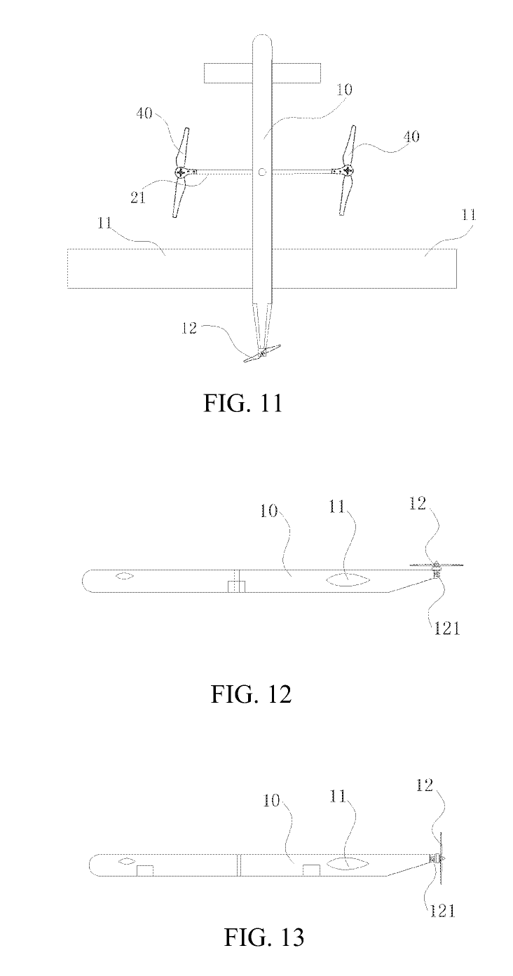

FIG. 11 is a top, perspective view of a VTOL fixed-wing aircraft according to a second embodiment of the present invention, during vertical take-off, landing or hover;

FIG. 12 is a side, perspective view of the VTOL fixed-wing aircraft according to a second embodiment of the present invention, during vertical take-off, landing or hover;

FIG. 13 is a side, perspective view of the VTOL fixed-wing aircraft according to a second embodiment of the present invention, during high speed cruise;

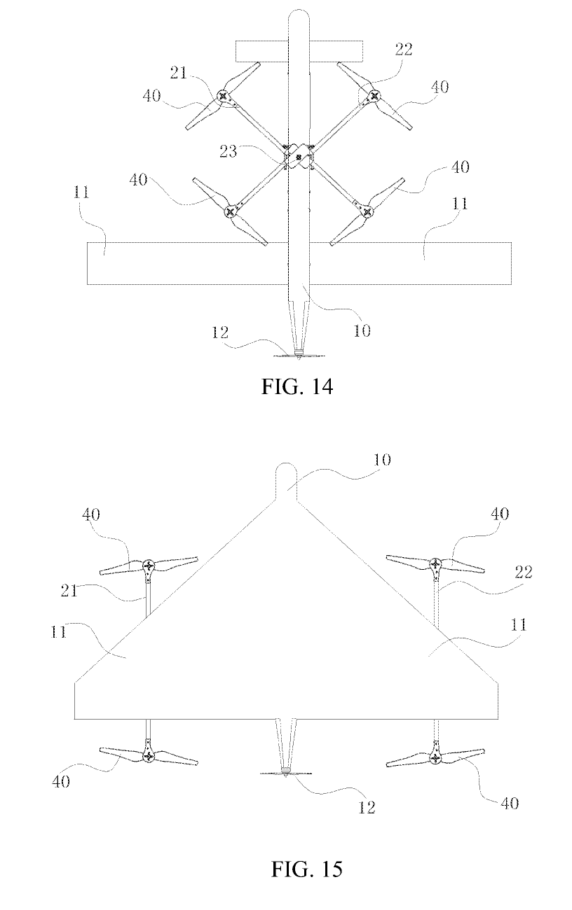

FIG. 14 is a top, perspective view of a VTOL fixed-wing aircraft according to a third embodiment of the present invention, during vertical take-off, landing or hover; and

FIG. 15 is a top, perspective view of a VTOL fixed-wing aircraft according to a forth embodiment of the present invention, during vertical take-off, landing or hover;

In the drawings and in the detailed part of the description, the following reference numerals have been used:
10 fuselage
11 fixed-wing
12 thruster
121 horizontal rotation shaft
13 storage room
14 door
141 hinge
142 door driving mechanism
143 active connecting rod
144 passive connecting rod
145 frame
15 horizontal stabilizers
16 vertical stabilizers
21 first supporting arm
211 first pin
22 second supporting arm
221 second pin
23 hinge shaft
231 outer shaft
232 inner shaft
24 hinge segment
25 first end arm
26 second end arm
30 driving mechanism
31 rotator
311 finger
32 slider
321 first slide element
322 second slide element
323 slot
33 guider
40 vertical lifter
41 installation base
42 rotary wing

### DETAILED DESCRIPTION

The following will be described hereinafter with reference to the following embodiments and figures.

### Embodiment 1

Referring to FIG. 1-10, a VTOL fixed-wing aircraft having a routine layout, comprises a fuselage 10, fixed-wings 11 arranged at the front part of the fuselage 10, horizontal stabilizers 15 and a vertical stabilizer 16 all arranged at the back end of the fuselage 10, and a thruster 12 configured behind the vertical stabilizer 16. A storage room 13 is configured inside the fuselage 10, a plurality of openings and their corresponding doors are configured on the fuselage 10, wherein the openings are connected to the storage room 13. A driving mechanism 30, and a deployable supporting mechanism driven by the driving mechanism 30 are arranged inside the storage room 13 of the fuselage, and the outer ends of the deployable supporting mechanism are provided with vertical lifters 40. The fixed-wing aircraft can be in an open state and a closed state. In the open state, the doors 14 open, and the vertical lifters 40 spread out outside the storage room 13, through the doors 14, by act of the deployable supporting mechanism. In the closed state, the vertical lifters 40 are located within the storage room 13 by act of the deployable supporting mechanism while the doors 14 closed.

Two doors 14 are located on both sides of the fuselage 10 respectively. Door driving mechanisms 142 are mounted on the fuselage 10, an L-shaped active connecting rod 143 and a passive connecting rod 144 are arranged between the door 14 and the door driving mechanism 142. Each door 14 is provided with a frame 145 connected to the passive connecting rod 144, and is hinged to the fuselage 10 by a hinge 141.

The deployable supporting mechanism comprises a first supporting arm 21 and a second supporting arm 22, the middle parts of both the first and second supporting arms 21, 22 are both movably hinged to a hinge shaft 23 mounted on the fuselage 10, to form an “X” shape, all ends of both the first supporting arm 21 and the second supporting arm 22 are provided with the vertical lifters 40, which means there are four vertical lifters 40 thereon.

Referring to FIGS. 5-8, each of the first supporting arm 21 and the second supporting arm 22 are arranged with a hinge segment 24, a first end arm 25 and a second end arm 26, and the first supporting arm 21 and the second supporting arm 22 are hinge-jointed via the hinge shaft 23 at their hinge segments 24. The first end arm 25 and the second end arm 26 are arranged on opposite sides of the hinge segment 24 respectively. The extension lines of the first and second end arms 25, 26 of the first supporting arm 21 are located on opposite sides of the hinge shaft 23, so do the extension lines of the first and second end arms 25, 26 of the second supporting arm 22; the extension lines of the first end arm 25 of both the first and second supporting arms 21, 22 are located on opposite sides of the hinge shaft 23, so do the extension lines of the second end arm 26 of both the first and second supporting arms 21, 22.

The hinge segment 24 of the first supporting arm 21 is located above the hinge segment 24 of the second supporting arm 22, and each of the first supporting arm 21 and the second supporting arm 22 includes an upper surface and a lower surface. The vertical lifter 40 includes an installation base 41 and a rotary wing 42 that fixed on the installation base 41. The installation bases 41 of two vertical lifters 40 on the first supporting arms 21 are mounted on the lower surface of the first supporting arm 21 and extend out of the outer ends of the first supporting arm, corresponding rotary wings 42 are fixed on the extended portion of the installation bases 41. The installation bases 41 of two vertical lifters 40 on the second supporting arms 22 are mounted on the upper surface of the second supporting arm 22 and extend out of the outer ends of the second supporting arm, corresponding rotary wings 42 are fixed on the extended portion of the installation bases 41. (see FIG. 8).

The first supporting arm 21 and the second supporting arm 22 are provided with a first pin 211 and a second pin 221 respectively, and the first pin 211 and the second pin 221 are located on opposite sides of the hinge shaft 23. Positive stops comprise the first pin 211 and the second pin 221. The first pin 211 and the second pin 221 are used to localize between the first supporting arm 21 and the second supporting arm 22, for instance, in the stop state, the first supporting arm 21 and the second supporting arm 22 are spread out maximally.

The driving mechanism 30 includes a rotator 31, a slider 32 and a guider 33. The rotator 31 and the guider 33 are arranged on the fuselage 10. The slider 32 is slid-fitted with the guider 33. The slider 32 is provided with a slot 323, and the rotator 31 is provided with a finger 311 which is inserted into the slot 323 and is deviated from the rotary axis of the rotator 31. A first slide element 321 and a second slide element 322 are arranged on the slider 32, the first pin 211 and the second pin 221 are inserted into the first slide element 321 and the second slide element 322 respectively. The hinge shaft 23 comprises an outer shaft 231 fixed to the first supporting arm 21, and an inner shaft 232 fixed to the second supporting arm 22, the outer shaft 231 is sleeved on the inner shaft 232.

The fixed-wings 11 are located on both sides of the fuselage 10, and the hinge shaft 23 is located near the back portion of the fixed-wing 11. In the open state, two vertical lifters 40 are located ahead of the fixed-wings 11.

This embodiment has the following advantages:
1. When the fixed-wing aircraft takes off, lands or hovers, the doors 14 open, and the deployable supporting mechanism is spread by act of the driving mechanism 30, thereby the vertical lifers 40 will be working outside the storage room 13 to provide the aircraft with large lift force in vertical direction; during the high speed cruise, the deployable supporting mechanism is gathered within the storage room 13, by act of the driving mechanism 30, that time the doors 14 close, and the thruster 12 works so as to make the aircraft to achieve a high efficiency and long range due to fully utilization of the aerodynamic efficiency of the fixed-wing 11.
2. In the open state, four vertical lifters 40 are located on both sides of the fuselage 10, to provide a lift force for the aircraft during vertical take-off and landing or hover, with a higher stability.
3. The deployable supporting mechanism comprises a first supporting arm 21, and two vertical lifters 40 are mounted to both ends of the first supporting arm 21 respectively so that the lift requirement can be perfectly met with simple structure.
4. The middle parts of the first supporting arm 21 and the second supporting arm 22 are all hinged to a hinge shaft 23 such that the first supporting arm 21 and the second supporting arm 22 form an “X” shape, such structure has the following advantages.
   A. When the first supporting arm 21 and the second supporting arm 22 are parallel, they are in a closed state, that is, the supporting arms 21, 22 and the vertical lifters 40 thereon are located in the storage room 13; when the first supporting arm 21 and the second supporting arm 22 are arranged at a certain angle, they are in an open state, and the vertical lifters 40 will be outside the storage room 13; the “X” shaped structure is simple and facilitate gathering and spreading;
   B. The hinged portions of the first supporting arm 21 and the second supporting arm 22 will bear a large bending moment. Such “X” shaped structure thereof ensure sufficient bending strength and rigidity in the hinged portion of the first supporting arm 21 and the second supporting arm 22;
   C. Such “X” shaped structure formed by both the first supporting arm 21 and the second supporting arm 22 allows larger expanded plane during the open state and smaller compact space during closed state.
   5. Each of the first supporting arm 21 and the second supporting arm 22 comprises the hinge segment 24, the first end arm 25 and the second end arm 26, the first end arm 25 and the second end arm 26 are arranged on opposite sides of the hinge shaft 23, ensuring the first supporting arm 25 and the second supporting arm 26 to be parallel during the closed state, to avoid more space being occupied due to incomplete gather thereof
   6. The first supporting arm 21 and the second supporting arm 22 all have a thickness, thus they cannot be in a same plane when they are hinge-jointed, which will affect the stability of the aircraft when it is vertically raised. During the installation, two vertical lifters 40 on the first supporting arms 21 are mounted on the bottom surface of the ends of the first supporting arms 21, and two vertical lifters 40 on the second supporting arms 22 are mounted on the top surface of the ends of the second supporting arms 22. This installation arrangement can ensure the four vertical lifters 40 being in a same horizontal plane to improve the stability of the aircraft.
   7. The relative position between the first supporting arm 21 and the second supporting arm 22 are limited by the first pin 211 and the second pin 221 in the open state, to ensure the reliability of the aircraft during flight.
   8. The first supporting arm 21 and the second supporting arm 22 are all provided with a first pin 211 and a second pin 221 respectively, the driving mechanism 30 may act on the first pin 211 and the second pin 221 that located on two opposite sides of the hinge shaft 23, then the first supporting arm 21 can rotate in reverse relative to the second supporting arm 22 to implement their gather or spread.
   9. The driving mechanism 30 comprises a rotator 31, a slider 32 and a guider 33, when the rotator 31 rotates, the finger 311 pushes the slider 32 to slide in horizontal direction along the guider 33, whereby the first pin 211 and the second pin 221 bring the first supporting arm 21 and the second supporting arm 22 to spread out or gather together.
   10. The hinge shaft 23 comprises an outer shaft 231 fixed to the first supporting arm 21, and an inner shaft 232 fixed to the second supporting arm 232. The sleeve structure of the outer shaft 231 has a larger thrust surface, which can reduce the possibility of skew or distortion between the first supporting arm 21 and the second supporting arm 22. Such sleeve structure is very important to ensure the reliability of the hinged portions.
   11. Two doors 14 are located on opposite sides of the fuselage 10 to facilitate the deployable supporting mechanism gathering together and spreading out.

### Embodiment 2

Referring to FIG. 11-13, two vertical lifters 40 are arranged on opposite sides of the fuselage 10 respectively in this embodiment, the fuselage 10 is further provided with a horizontal rotation shaft 121, the thruster 12 is movably mounted to the fuselage 10 via the rotation shaft.

Both sides of the fuselage 10 are all provided with a vertical lifter 40 to improve balance of the aircraft when take-off, landing or hover, the thruster 12 is movably mounted to the fuselage 10 via the horizontal rotation shaft 121. During high-speed cruise, the thruster 12 offers thrust power, and during take-off, landing or hover, the thruster 12 rotates around the horizontal rotation shaft 121 until its own axis being vertical then the thruster 12 acts as a pitch control mechanism to provide an auxiliary lift force.

### Embodiment 3

Referring to FIG. 14, the fixed-wing aircraft in this embodiment uses canard configuration, the principle and rest structures are same as embodiment 1.

### Embodiment 4

Referring to FIG. 15, this embodiment uses fly-wing configuration in which the fixed-wings are integrated with the fuselage, namely fly-wing. A thruster 12 is arranged on the fly-wing, the fixed-wing 11 is provided with a plurality of openings all connected to the storage room 13, and corresponding doors 14, the principle and rest structures are same as embodiment 1. In this embodiment, more space can be left to make the structure more compact.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A vertical take-off and landing fixed-wing aircraft, comprising:
a fuselage, fixed-wings and a thruster both configured in the fuselage;
a storage room configured inside the fuselage;
a plurality of openings and corresponding doors are configured on the fuselage, and the plurality of openings are connected to the storage room; and
a driving mechanism, and a deployable supporting mechanism driven by the driving mechanism arranged inside the storage room, and outer ends of the deployable supporting mechanism are provided with vertical lifters;
wherein the vertical take-off and landing fixed-wing aircraft can be in an open state and a closed state, and in the open state, the doors open and the vertical lifters spread out outside the storage room through the doors, by an act of the deployable supporting mechanism, and in the closed state, the vertical lifters are located within the storage room by an act of the deployable supporting mechanism while the doors are closed.

2. The fixed-wing aircraft of claim 1, wherein at least two vertical lifters are arranged, and in the open state, the at least two vertical lifters are located on opposite sides of the fuselage.

3. The fixed-wing aircraft of claim 2, wherein the fuselage is further provided with a horizontal rotation shaft, the thruster being movably mounted to the fuselage via the horizontal rotation shaft.

4. The fixed-wing aircraft of claim 2, wherein the deployable supporting mechanism comprises a first supporting arm, a middle part of the first supporting arm being movably connected to the fuselage via a hinge shaft, further wherein at least two vertical lifters are mounted on both ends of the first supporting arm.

5. The fixed-wing aircraft of claim 4, wherein the deployable supporting mechanism further comprises a second supporting arm, a middle part of the second supporting arm and the middle part of the first supporting arm being movably hinged to the hinge shaft, to form an “X” shape, all outer ends of both the first supporting arm and the second supporting arm are provided with the vertical lifters respectively, the hinge shaft being connected to the fuselage.

6. The fixed-wing aircraft of claim 5, wherein the first supporting arm and the second supporting arm are both arranged with a hinge segment, a first end arm and a second end arm; the first supporting arm and the second supporting arm being hinge-jointed via the hinge shaft at their hinge segments, and the first end arm and the second end arm are arranged on opposite sides of the hinge segment respectively; the hinge segment of the first supporting arm is located above that of the second supporting arm, and each of the first supporting arm and the second supporting arm includes an upper surface and a lower surface, the vertical lifter includes an installation base and a rotary wing that fixed on the installation base; two vertical lifters on the first supporting arms mounted on the lower surface of the first supporting arm via their installation base, and two vertical lifters on the second supporting arms mounted on the upper surface of the second supporting arm via their installation base.

7. The fixed-wing aircraft of claim 5, wherein positive stops are provided about the first supporting arm and the second supporting arm, the first supporting arm and the second supporting arm spread out maximumly at a stop state.

8. The fixed-wing aircraft of claim 7, wherein the first supporting arm and the second supporting arm are provided with a first pin and a second pin respectively, and the first pin and the second pin are located on opposite sides of the hinge shaft; the positive stops comprise the first pin and the second pin.

9. The fixed-wing aircraft of claim 8, wherein the driving mechanism comprises a rotator, a slider and a guider; the rotator and the guider arranged on the fuselage, and the slider is slid-fitted with the guider; the slider provided with a slot, and the rotator provided with a finger which is inserted into the slot and is deviated from a rotary axis of the rotator; a first slide element and a second slide element arranged on the slider, the first pin and the second pin inserted into the first slide element and the second slide element respectively.

10. The fixed-wing aircraft of claim 5, wherein the hinge shaft comprises an outer shaft fixed to the first supporting arm, and an inner shaft fixed to the second supporting arm; the outer shaft being sleeved on the inner shaft.

11. The fixed-wing aircraft of claim 5, wherein the doors are two doors which are respectively located on opposite sides of the fuselage.

12. A vertical take-off and landing fixed-wing aircraft, comprising:
a fuselage, fixed-wings and a thruster both configured in the fuselage;
a storage room configured inside the fixed-wings, a plurality of openings and their corresponding doors configured on the fixed-wing, and the plurality of openings are connected to the storage room; and
a driving mechanism, and a deployable supporting mechanism driven by the driving mechanism are arranged inside the fixed-wings, and the outer ends of the deployable supporting mechanism are provided with vertical lifters;
wherein the vertical take-off and landing fixed-wing aircraft can be in an open state and a closed state, and in the open state, the doors open and the vertical lifters spread out outside the storage room through the doors, by the act of the deployable supporting mechanism, and
in the closed state, the vertical lifters are located within the storage room by act of the deployable supporting mechanism while the doors are closed.

13. The fixed-wing aircraft of claim 12, wherein the fixed-wings are two fixed-wings which are arranged on opposite sides of the fuselage, each fixed-wing is fixed with two vertical lifters by the deployable supporting mechanism.

14. The fixed-wing aircraft of claim 12, wherein the vertical lifters are two vertical lifters; the fuselage is provided with a horizontal rotation shaft, and the thruster is movable mounted to the fuselage via the rotation shaft.

15. (canceled)
